(19) United States
(12) Patent Application Publication
(10) Pub. No.: US 2026/0158699 A1
(43) Pub. Date: Jun. 11, 2026

(54) LATHE DEVICES, SYSTEMS, AND METHODS FOR THE MANUFACTURE OF BOWLS

(71) Applicant: Pacific Rim Tonewoods, Inc., Concrete, WA (US)

(72) Inventor: Jake A. Wells, Concrete, WA (US)

(21) Appl. No.: 19/408,284

(22) Filed: Dec. 3, 2025

Related U.S. Application Data
(60) Provisional application No. 63/728,634, filed on Dec. 5, 2024.

(51) Int. Cl. B27C 7/04; B27M 3/00

(52) U.S. Cl. CPC B27C 7/04; B27M 3/00

(57) ABSTRACT

Introduced herein are devices, systems, and methods to machine a bowl efficiently and consistently from a billet. A billet can be secured to a first mounting device at a first lathe station, and a rough core having an index groove can be machined from the billet using a plurality of lathe operating techniques applied to a plurality of surfaces of the billet. The rough core having an index groove can be mounted to a second mounting device at a second lathe station, and a plurality of lathe operating techniques can machine a plurality of surfaces of the rough core mounted to the second mounting device at the second lathe station. The rough core can be mounted to a third mounting device at the second lathe station, and a plurality of lathe operating techniques can machine a plurality of surfaces of the rough core, forming a bowl having machined surfaces.

### CROSS-REFERENCE TO RELATED APPLICATION

This application claims the benefit of U.S. Provisional Patent Application No. 63/728,634, filed December 5, 2024, and titled “LATHE DEVICES, SYSTEMS, AND METHODS FOR THE MANUFACTURE OF BOWLS,” which is incorporated herein by reference in its entirety.

### TECHNICAL FIELD

Embodiments of the present technology relate generally to lathe devices, systems, and methods used in the manufacture of an article.

### BACKGROUND

Traditional lathe devices, systems, and methods used in the manufacture of bowls and similar items can be inefficient, time-consuming, labor-intensive, and produce variable quality. In addition, the wood workpiece from which the bowl is machined on a lathe requires formation of a relatively small tenon on the bottom of the workpiece so that the workpiece can be clamped into a chuck that mounts to the lathe. The tenon can be exposed to significant forces during the machining process to form the bowl, and failure or flaws in the relatively small tenon can create significant problems with holding the workpiece and providing consistent repeatability for forming consistent bowls during high-volume production work. There is a need for improved lathe devices, systems, and methods used in the manufacture of bowls and similar concave items, particularly in a high-volume production of multiple units.

### BRIEF DESCRIPTION OF THE DRAWINGS

Embodiments of the technology introduced herein can be better understood by referring to the following Detailed Description in conjunction with the accompanying drawings, in which like reference numerals indicate identical or functionally similar elements.

FIG. 1 is a general schematic of a lathe system in accordance with embodiments of the technology disclosed herein.

FIG. 2A is a perspective view of a wood workpiece, referred to as a rough core in accordance with embodiments of the technology disclosed herein.

FIG. 2B is an image illustrating a billet from which the rough core of FIG. 2A is machined.

FIG. 3 is an image illustrating a coring station in accordance with embodiments of the technology disclosed herein.

FIG. 4A is an image illustrating components of the coring station of FIG. 3.

FIG. 4B is an image illustrating an embodiment of a billet mounted to the coring station of FIG. 3 before the rough core is cut from the billet.

FIG. 4C is an image illustrating a partial rough core on the coring station of FIG. 3 after being cut from the remaining portion of the billet (shown on the ground).

FIG. 4D is an image illustrating the partial rough core mounted to the coring station of FIG. 4C, wherein the rough core has an index groove formed thereon in accordance with embodiments of the technology disclosed herein.

FIG. 4E is an enlarged image illustrating the partial rough core mounted on the coring station of FIG. 4C and positioned adjacent to a curved coring knife for creating a partially spherical cut forming an interior or exterior surface of the rough core, wherein the exterior surface of the rough core is shown with an index groove in accordance with embodiments of the technology disclosed herein.

FIG. 5 is an image illustrating a cutting tool for forming the index groove in the partial rough core of FIG. 4E.

FIG. 6 is a side elevation view of a rough core with the index groove.

FIG. 7 is an image illustrating the rough core mounted in a star chuck assembly mounted on a lathe in a lathe system for machining a concave interior surface and edge portion of the rough core in accordance with embodiments of the technology disclosed herein.

FIG. 8 is an enlarged image illustrating the star chuck of FIG. 6 shown removed from the lathe.

FIG. 9A is an enlarged image illustrating an exterior surface of the rough core with the index groove and a jaw of the star chuck of FIG. 7 engaging the index groove to hold the rough core for machining.

FIG. 9B is an enlarged cross-sectional view showing various profiles of an index groove in accordance with embodiments of the technology disclosed herein.

FIG. 10 is an image illustrating a lathe of the lathe system with a vacuum chuck configured to hold the rough core for machining its convex exterior surface to form a bowl in accordance with embodiments of the technology disclosed herein.

FIG. 11A is an enlarged partial image illustrating the vacuum chuck of FIG. 10 shown removed from the lathe.

FIG. 11B is an enlarged side elevation view of a portion of the vacuum chuck of FIG. 10 interfacing with the top edge of the rough core.

FIG. 12 is an image illustrating an automated robotic assembly of the lathe system to hold and position cutting and other machining tools to machine the interior and exterior surfaces of the rough core to form the wooden bowl.

FIGS. 13A and 13B are images illustrating an end effector of the automated robotic assembly of FIG. 12.

FIG. 13C illustrates end effectors removed from the robot and stored in a tool station.

FIG. 14A illustrates a multipart lathe tool connected to an end effector of the robotic assembly of FIG. 8 in accordance with embodiments of the technology disclosed herein.

FIGS. 14B and 14C are images illustrating portions of the multipart lathe tool of FIG. 14A.

FIG. 15 is a schematic of a lathe station in accordance with embodiments of the technology disclosed herein.

FIG. 16 is a schematic flow chart for a process for manufacturing a bowl with the lathe system in accordance with embodiments of the technology disclosed herein.

The headings provided herein are for convenience only and do not necessarily affect the scope or meaning of the claimed embodiments. Further, the drawings have not necessarily been drawn to scale. For example, the dimensions of some of the elements in the figures have been expanded or reduced to help improve the understanding of the embodiments. Moreover, while the disclosed technology is amenable to various modifications and alternative forms, specific embodiments have been shown by way of example in the drawings and are described in detail below. The intention, however, is not to limit the embodiments described. On the contrary, the embodiments are intended to cover all modifications, equivalents, and alternatives falling within the scope of the embodiments.

### DETAILED DESCRIPTION

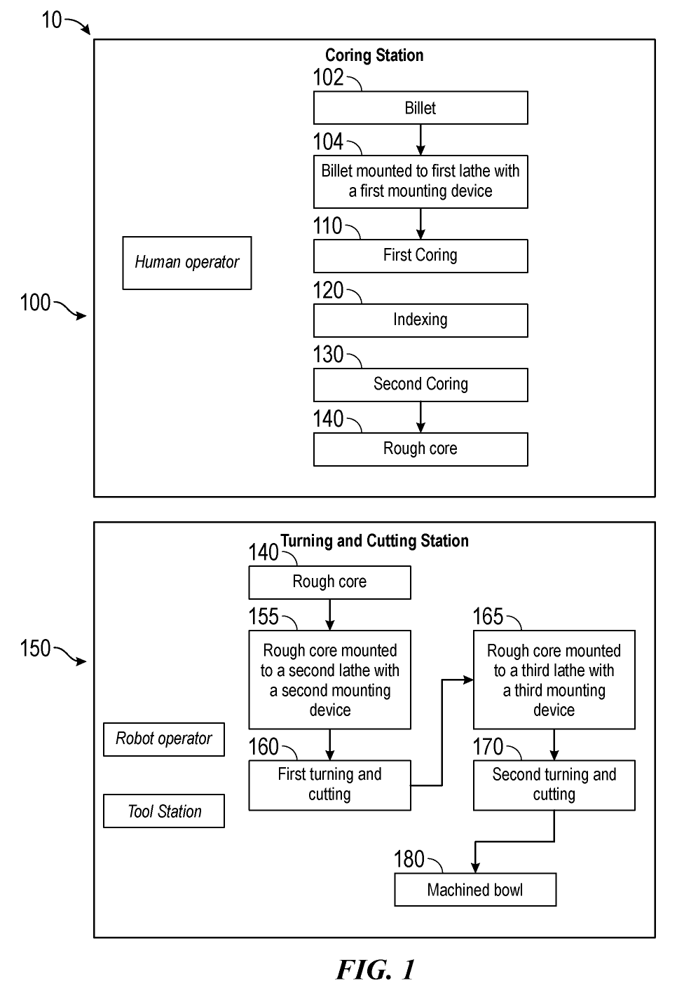

The present technology is generally directed towards devices, systems, and methods used in the manufacture of bowls from a billet of material. In some embodiments, the billet is a portion of a tree trunk of a selected wood (e.g., hardwood, softwood, etc.). Aspects of the present technology overcome the drawbacks of traditional methods used to manufacture bowls and provide other benefits. Specific details of several embodiments of the present technology are described herein with references to FIGS. 1-16. Although many of the embodiments are described with respect to devices, systems, and methods for the manufacture of a bowl, other applications and other embodiments, in addition to those described herein, are within the scope of the present technology. For example, some embodiments of the present technology can be useful for manufacturing bowls or other similar concave/convex structures made of wood or other materials, such as plastics, metals, etc. Further, other embodiments of the present technology can have different configurations, components, and/or procedures than those shown or described herein.

The following description of aspects of the current technology provides specific details for a thorough understanding and enabling description of these examples. One skilled in the relevant art will understand, however, that the technology discussed herein can be practiced without many of these details. Likewise, one skilled in the relevant art will also understand that the technology can include many other features not described in detail herein. Additionally, some well-known structures or functions are not shown or described in detail below to avoid unnecessarily obscuring the relevant description.

The terminology used below is to be interpreted in its broadest reasonable manner, even though it is being used in conjunction with a detailed description of some specific examples of the embodiments. Indeed, some terms can even be emphasized below; however, any terminology intended to be interpreted in any restricted manner will be overtly and specifically defined as such in this section.

The embodiments of the present technology described below include one or more lathe systems and components to machine a wood workpiece into a substantially finished wood bowl. The lathe systems utilize mounting devices configured to removably receive a workpiece such that the workpiece is fixedly secured in the mounting device and able to rotate with the mounting device as a unit while withstanding the forces and loads generated during cutting or otherwise removing material from the workpiece during the lathe/machining processes. The mounting device is further capable of being removably coupled to a lathe, either alone or with the workpiece secured to it. In some embodiments, a mounting device can be a chuck assembly. A chuck assembly can have different forms and different means of securing the workpiece. For example, a chuck assembly can have a screw end that removably screws into a workpiece. As another example, a chuck assembly can have adjustable jaws that clamp onto a workpiece. As another example, a chuck assembly can have adjustable retainers that frictionally engage a workpiece. As another example, a chuck assembly can have means to provide a vacuum such that a workpiece is secured to the chuck assembly by the vacuum. It should be understood that a mounting device can use a combination of methods to secure a workpiece, such as the use of both retainers and a vacuum, among other combinations.

A lathe used in the present technology rotates a workpiece about an axis of rotation so machining tools, such as cutting tools, shaping tools, finishing tools, etc., can be used to engage and remove materials from the workpiece to result in a desired shape and configuration of the machined workpiece. For example, a lathe operating process can include coring, indexing, milling, cutting, knurling, sanding, chamfering, contouring, parting, smoothing, or polishing, among others. Lathe tools can include curved knives, chisels, borers, reamers, facers, cutters, sanding tools, among others. In some embodiments of a lathe operating technique, a human operator can engage a tool with a surface of a workpiece to accomplish aspects of the lathe operating technique. In other embodiments of a lathe operating technique, a robot having an end effector, wherein a tool is mounted to the end effector, can engage the tool to a surface of a workpiece to accomplish the lathe operating technique.

Lathe systems can include the use of one or more lathes to manufacture an article. In some embodiments, the one or more lathes can be disposed at one or more lathe stations, wherein specified lathe operating techniques are accomplished at the lathe station. For example, a lathe system can include a first lathe station having a first lathe, and a second lathe station having a second lathe and a third lathe. The first lathe station can be a coring station, wherein various lathe operating techniques, such as coring, are used to machine a rough core from a billet mounted to the first lathe. The second lathe station can be a turning and cutting station that uses various lathe operating techniques, such as turning, cutting, or sanding, among others, to machine the rough core while mounted to the second lathe and/or the third lathe to result in a substantially finished wooden bowl.

Some embodiments of the present technology provide a method of machining a bowl from a rough core. The method comprises mounting the rough core to a first chuck configured to mount to a first lathe, wherein the rough core is formed from a billet and includes a convex rough exterior surface, a concave rough interior surface, a rough top edge, and an index groove in the convex external surface adjacent to the rough top edge. The first chuck has one or more adjustable engagement features that securely engage the convex external surface of the rough core in the index groove. The first chuck is coupled to the first lathe, and the rough core and the first chuck are turned as a unit about a first axis of rotation via the first lathe. The method includes machining with one or more cutting tools the rough interior surface and the rough top edge of the rough core while turning via the first lathe to form an intermediate core with a machined interior surface and a machined top edge, removing the intermediate core from the first chuck, and securing the intermediate core to a second chuck with the machined top edge in firm engagement with the second chuck, wherein the second chuck is configured to mount to the first lathe or a second lathe. The second chuck is coupled to the first lathe or the second lathe, and the intermediate core and the second chuck are turned as a unit via the first lathe or the second lathe. The method further includes machining with one or more cutting tools the rough exterior surface to form a bowl with a machined exterior surface, wherein the machining of the rough exterior surfaces removes material of the intermediate core comprising the index groove to remove the index groove. The bowl is then removed from the second chuck.

Another aspect of the present technology provides a lathe system that comprises one or more lathes, each having central axes of rotation and configured to rotate a workpiece about the central axes of rotation, wherein the workpiece has a convex rough external surface. A cutting assembly has a movable arm and a first cutting tool fixedly coupled to the movable arm, wherein the movable arm is configured to move the cutting tool into engagement with the rough external surface of the workpiece while rotating about the central axis of rotation to form an index feature into a convex exterior surface adjacent to an upper edge portion of the workpiece. One or more cutting tools are configured to engage and remove material from the rough core. First and second chuck assemblies are configured to removably mount to the one or more lathes and to releasably retain a rough core formed from the workpiece, wherein the rough core comprises the convex rough external surface with the index feature formed therein, the rough upper edge portion, and a rough convex interior surface. The first chuck assembly comprises a plurality of adjustable engagement features that securely engage the convex rough external surface of the rough core in the index feature adjacent to the upper edge portion to rotate the rough core with the first chuck as a unit in a position configured to allow material to be machined from the rough interior surface and the upper edge portion and a portion of the rough exterior surface between the upper top edge and the index feature using the one or more second cutting tools to form a machined interior surface and a machined top edge of a bowl. The second chuck assembly comprises a mounting plate and a plurality of engagement features configured to engage with the machined interior surface of the intermediate core adjacent to the machined top edge of the bowl, wherein the second chuck assembly is configured to hold and rotate with the intermediate core in a configuration to allow material to be machined from the rough exterior surface, including a portion of the rough exterior surface comprising the index feature to form a machined exterior surface of the bowl, using the one or more second cutting tools.

Another embodiment of the present technology provides a lathe station system comprising one or more lathes configured to rotate a workpiece about central axes of rotation. A star chuck assembly is mountable to the one or more lathes. The star chuck assembly includes a base and a plurality of curved jaw arms adjustably coupled to the base. Each of the plurality of curved jaw arms has a distal end configured to extend at least partially into an index feature positioned on a convex exterior surface of the workpiece near a top edge portion of the workpiece, and an adjustment mechanism configured to move the plurality of curved jaw arms radially relative to the base to hold onto or release the workpiece from the plurality of curved jaw arms. A vacuum chuck assembly is mountable to the one or more lathes. The vacuum chuck has a vacuum port configured to draw a vacuum, and a plurality of engagement features configured to releasably engage with a concave interior surface of the workpiece. A robotic arm assembly has a connection member on a free end to releasably hold one or more cutting tools, wherein the robotic arm is configured to move the one or more cutting tools to machine the concave interior surface, the top edge portion and a portion of the convex exterior surface between the index feature of the workpiece while the workpiece is mounted to the star chuck assembly, and configured to machine the convex exterior surface and the concave interior surface while the workpiece is mounted to the vacuum chuck assembly, such that the material in which the index feature is formed is fully removed.

Referring now to the figures, FIG. 1 illustrates a general schematic of a lathe system 10, in accordance with embodiments of the technology disclosed herein. Lathe system 10 can include a coring station 100 and a turning and cutting station 150. When viewed as a whole, lathe system 10 can machine a billet into one or more rough cores, and machine each rough core to a finished bowl utilizing a minimized number of times the rough core needs to be mounted or re-mounted onto portions chucks or other mounting devices of the lathe system to result in the substantially finished bowl product. In the embodiments of the lathe system 10 described below, the billet is made of a selected piece of wood, such as a portion of a tree trunk, and the finished product is one or more wood bowls formed from the billet. The finished bowl may be untreated wood that may be further sanded and/or coated with an oil, sealant, stain, or other coating for the final bowl product.

The coring station 100 can be used to machine a rough core from a billet 102. The coring station 100, in some embodiments, can have a human operator, a first turning assembly (e.g., a lathe) that receives a first mounting device to which the billet 102 can be removably mounted, so that the mounting device 104 and billet 102 will be rotated as a unit by the lathe. The operator can use a selected lathe tool, such as curved cutting tools, to cut a portion of the billet 102 into a semispherical or partially spherical-shaped rough core. For example, one cutting tool can be used to cut the billet material to form a convex exterior surface of the rough core. A second, smaller cutting tool can be used to cut the billet material to form a concave interior surface, so that the rough core generally resembles a rough bowl having unrefined interior and exterior surfaces and an upper edge that extends between the interior and exterior surfaces. As discussed in greater detail below, the rough core does not need or include a tenon on the bottom of the workpiece. Instead, the coring station can be configured to cut or otherwise form one or more index features, such as an index groove machined into the core’s convex exterior surface, a selected distance between the upper edge portion and the core’s bottom end. Accordingly, the exterior of the rough core will have an upper convex portion between the index feature(s) and the core’s upper edge portion, and a lower convex portion below the upper convex portion. The index feature(s) may be in the lower convex portion slightly below the upper convex portion.

The billet 102 can be removably mounted to a first mounting device 104, wherein the first mounting device screws into or otherwise securely engages a flat surface of the billet 102 for turning the billet about the mounting device’s axis of rotation. As discussed in greater detail below, once the billet 102 is secured on the mounting device 104 and rotated, a curved coring knife or cutting tool with a first radius is used to perform a first coring process 110 to machine a substantially semispherical body from the rest of the billet. This first coring process 110 can be accomplished manually or partially manually so the operator can carefully control the cutting rate and pressure of the coring knife and the associated cutting of the billet material. In other embodiments, the first coring process 110 can be automated. The result of the first coring process is a semispherical body that has the convex exterior surface of the rough core.

Once the semispherical body is cut from the billet, and while the semispherical body is still secured to the first mounting device and rotating on the first lathe, another cutting tool can be used to cut or otherwise machine an index groove 120 or other index features(s) into or on the convex exterior surface of the rotating body. As discussed in greater detail below, the index feature(s) is configured to receive engagement members of a chuck assembly to hold the rough core for further machining by the lathe system. The rotating semispherical body is further machined with a second, smaller coring knife or cutting tool that has a radius smaller than the first coring knife to perform a second coring process 130 to machine a concave interior surface into the rotating body, forming the rough core 140. The smaller coring knife is configured so that the rough core’s concave interior surface is generally parallel to the rough core’s convex exterior surface. Accordingly, the rough core 140 will have a generally rough, unfinished bowl shape with the index groove positioned generally close to the top edge portion of the rough core 140.

In some embodiments, the first coring process 110 and the second coring process 130 can occur before the index groove 120 or other index feature(s) is cut into the exterior surface of the rough core 140. For example, after the first coring process 110 and the second coring process 130, the rough core 140 can be dried to substantially reduce the moisture content within the rough core 140. In some embodiments, a support can be used with the rough core 140 to help control and/or reduce warping and/or shrinking of the rough core 140 during drying. After the rough core 140 is sufficiently dried, it can be attached to an additional lathe via a chuck, such as a vacuum or a star chuck, for machining of the index groove 120 or other index feature(s) into or on the convex exterior surface of the rotating body.

Once the rough core 140 is machined, it can be transferred to a separate turning and cutting station 150, where the rough core is further machined to provide the substantially finished wooden bowl product. The turning and cutting station 150 can be an automated, robotic station with one or more computer-controlled systems with a robot having cutting or machining tools attachable to an end effector to precisely and efficiently perform the lathe operations to transform the rough core into the finished bowl, as discussed below. For example, the rough core can be mounted to a second lathe via a mounting device 155, and a turning and cutting process 160 is applied to a portion of the rough core to partially finish part of the rough core. The partially finished rough core can be mounted to a third lathe via another mounting device 165, and another turning and cutting process 170 is applied to the remaining portion of the rough core to substantially complete machining to form the wood bowl 180.

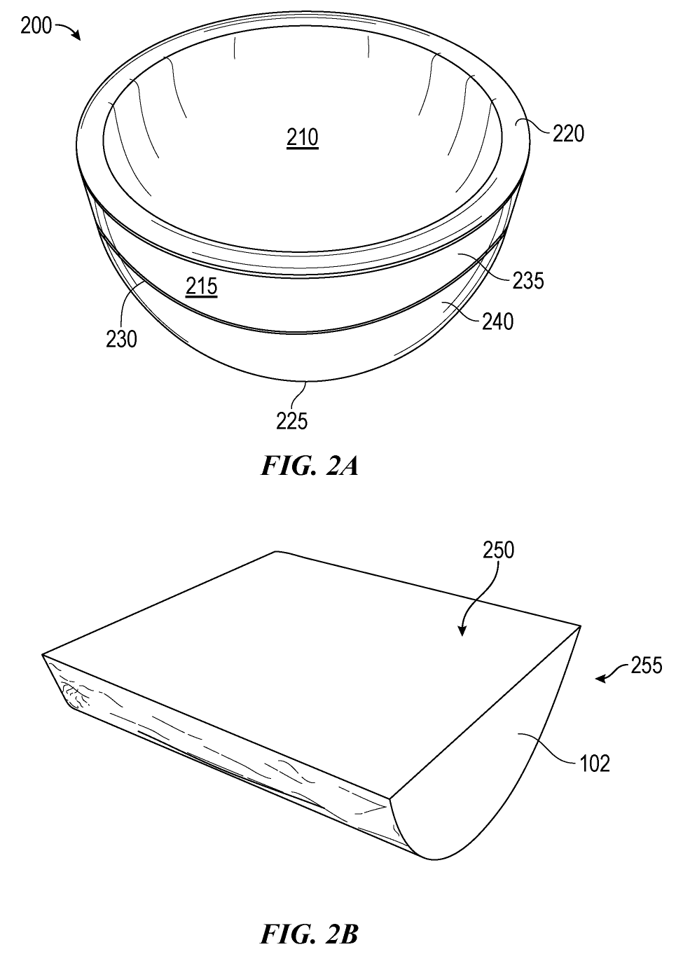

Referring now to FIGS. 2A and 2B, an embodiment of a rough core 200 (FIG. 2A) is illustrated that was machined from the billet 102 (FIG. 2B) and configured to be further machined via one or more lathes to form a finished wooden bowl of a selected shape and size. The illustrated rough core 200 has the concave interior surface 210, the convex exterior surface 215, an upper edge portion 220 extending between the interior and exterior surfaces 210 and 215, and a bottom end portion 225 opposite the upper edge portion 220. The index feature in the illustrated embodiment is an index groove 230 formed in the convex exterior surface 215 around the core’s circumference and at a position typically closer to the upper edge portion 220 than to the bottom end portion 225. The convex exterior surface 215 can have an upper convex portion 235 extending between the upper edge portion 220 and a position slightly above the index groove 230, and a lower convex portion 240 extending between the upper convex portion 235 and the rough core’s bottom end portion 225. Accordingly, in some embodiments, the index groove 230 is in the lower convex portion 240 generally adjacent to the upper convex portion 235.

The rough core 200 is cut or otherwise formed from a billet 102 (FIG. 2B) of a selected material. The billet 102 of the illustrated embodiment is a segment of selected wood having a semi-cylindrical shape, such that the billet has a substantially rectangular flat face 250 extending between the edges of a curved outer surface 255. As those skilled in the art will appreciate, the billet 102 can vary in size, shape, and contain imperfections. For example, the billet 102 can be a portion of a tree trunk, wherein the curved outer surface 255 can be the exterior of the tree with rough bark. In some embodiments, when the rough core 200 (FIG. 2A) is cut from the billet 102 (FIG. 2B), the rough core’s upper edge portion 220 corresponds to a circular segment of the billet’s flat face 250. While the rough core 200 is described in connection with embodiments as being wood, the rough core 200 can be made of other materials, such as plastic, metal, blended materials, etc.

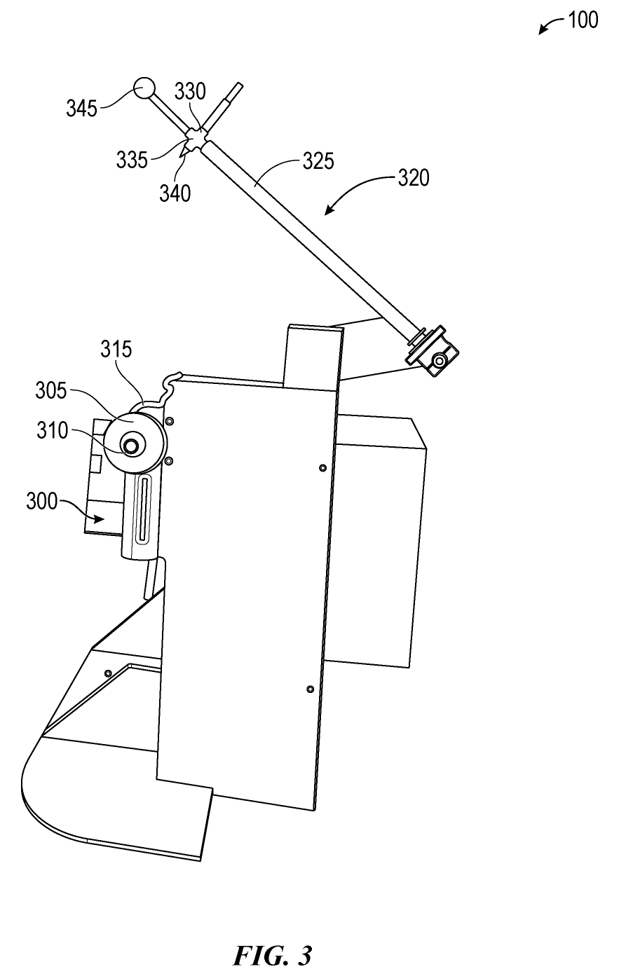

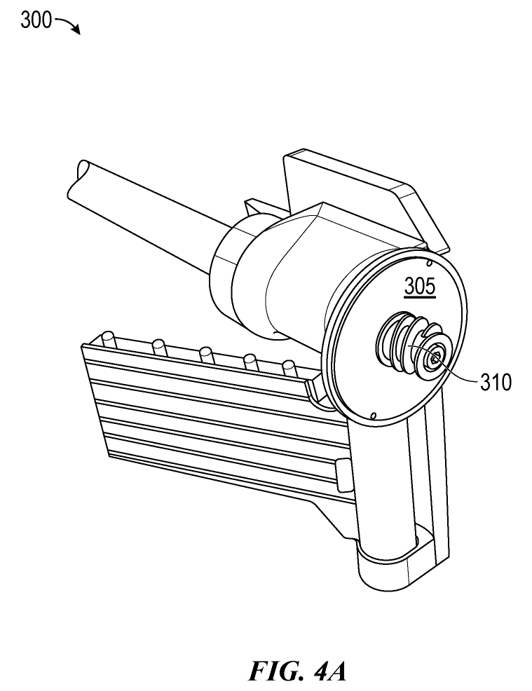

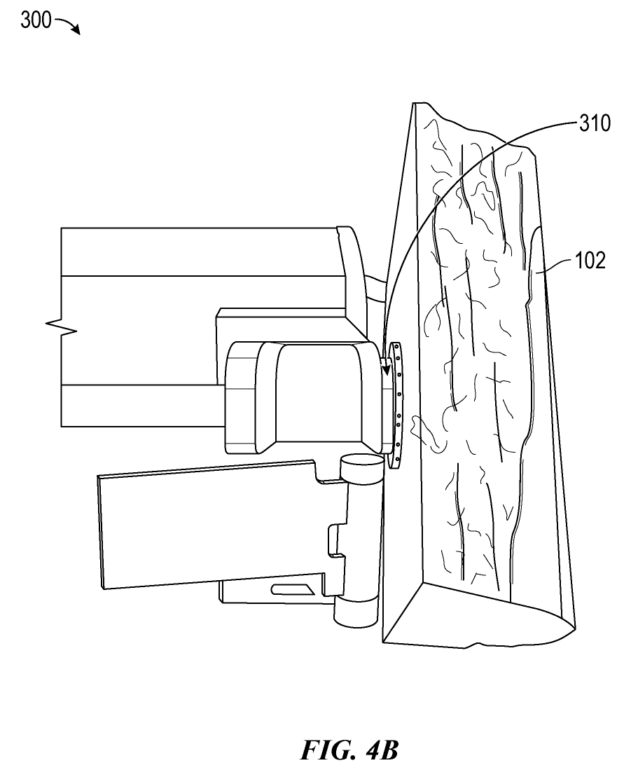

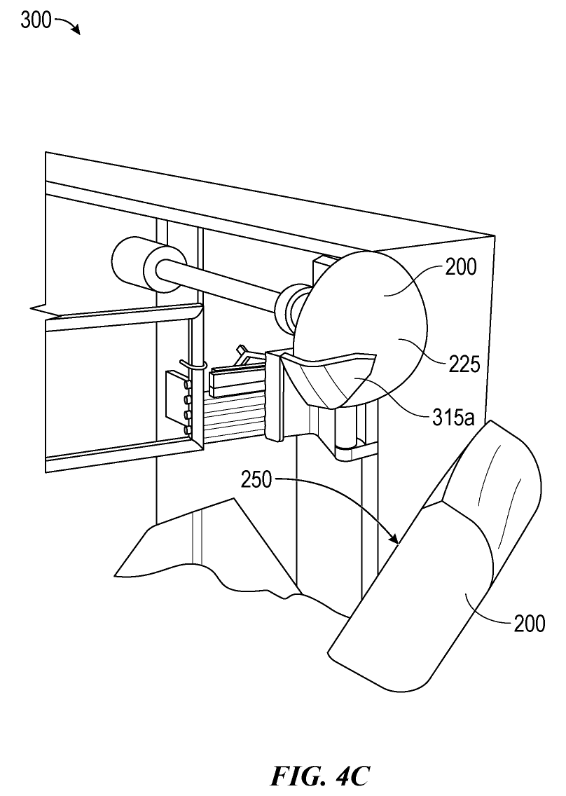

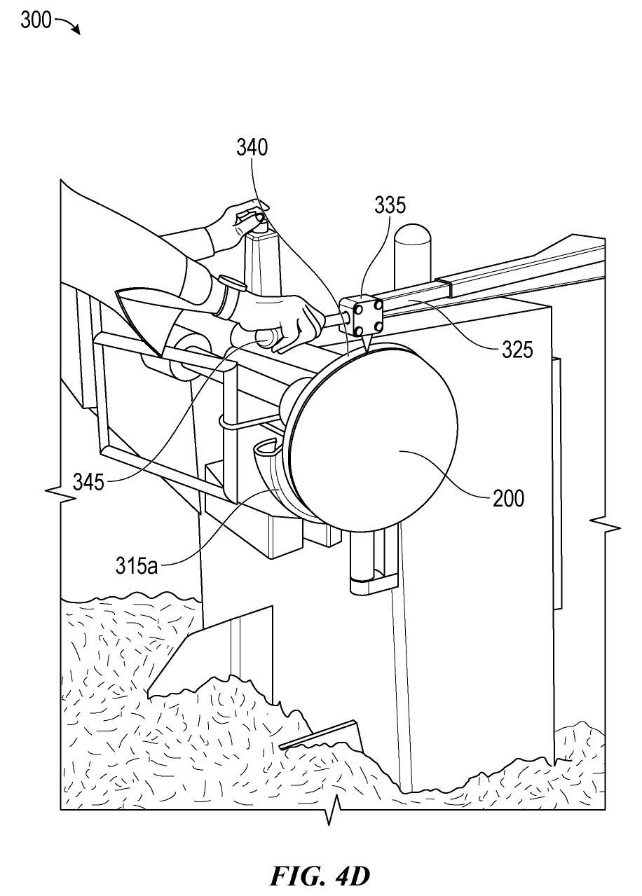

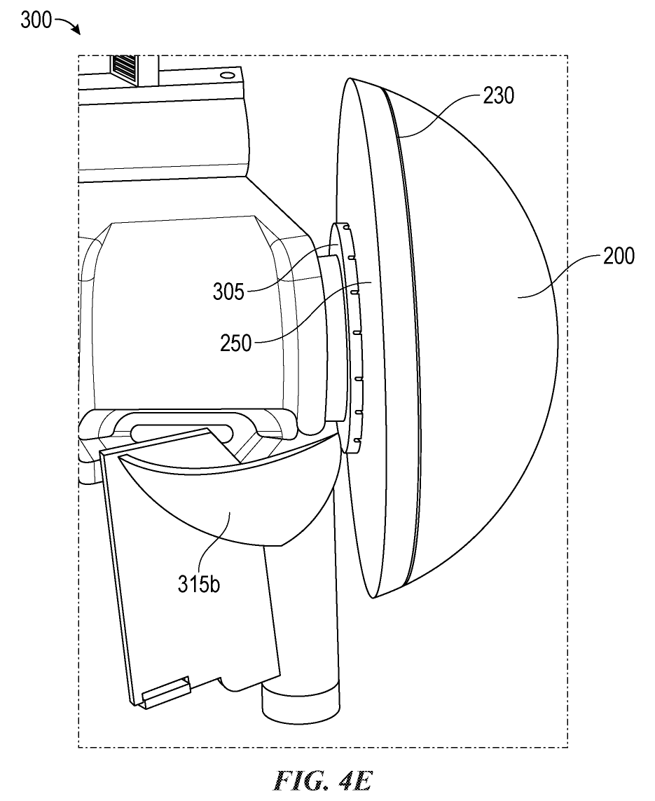

The illustrated rough core 200 is cut from a selected billet 102 at the coring station 100 (FIG. 3) that has a first lathe 300 to which the billet 102 (FIG. 2B) is removably attached and rotated about an axis of rotation. As seen in FIGS. 3 and 4A, the lathe 300 has an engagement portion 305 with a threaded screw chuck 310 configured to screw into the billet 102 (FIG. 4B) so as to firmly hold and rotate the billet 102 when the lathe 300 is turned on. In some embodiments, the screw chuck 310 is configured to screw into the flat face 250 of the billet 102 (FIG. 2B), so as the lathe 300 rotates the billet 102, the rotating flat face 250 is positioned adjacent to a selected cutting tool, such as a curved coring knife 315. The lathe 300 is configured to move the coring knife 315 along an arcuate cutting path to cut the billet material along a partially spherical path. In the illustrated coring station 100, the lathe 300 can removably receive a plurality of cutting tools to selectively cut the material of the billet 102 to form the rough core. For example, when the billet 102 is mounted to the lathe 300 (FIG. 4B), the first curved coring knife 315a (FIG. 4C) having a first radius is used to cut the billet from the flat face 250 to form the semi-spherical exterior surface 215 of the resulting rough core 200. After the billet is cut with this first coring knife, as seen in FIG. 4C, the resulting rough core 200 remains mounted on the lathe’s screw chuck (not visible), and the rest of the billet 102 falls away from the rough core 200, leaving the exterior surface 215 exposed. This coring process at the coring station may be performed manually, automatically (e.g., via a computer-controlled robotic system), or a combination of manual and automated processes.

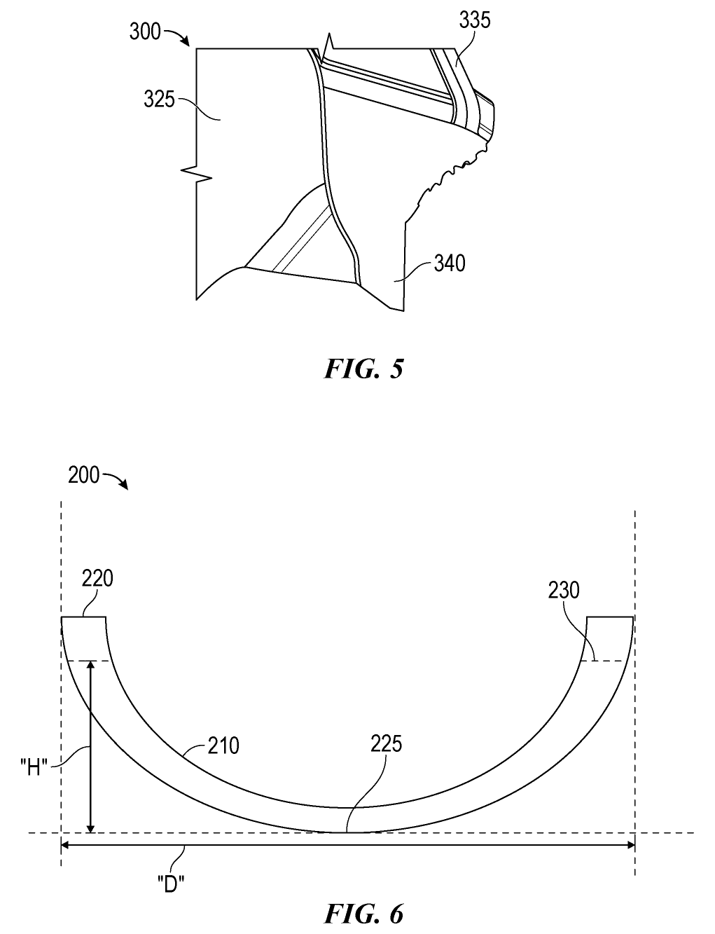

Referring again to FIG. 3, the coring station 100 has another cutting assembly 320 comprising an arm 325 pivotally attached at a proximal portion to the lathe 300. As seen in FIG. 5, the distal portion 330 of the arm has a tool holder 335 that releasably retains a cutting tool 340, such as an indexing knife. The arm 325 of the cutting assembly 320 (FIG. 3) is configured to be movable to bring the cutting tool 340 into engagement with the exterior surface 215 of the rough core 200 while the lathe 300 is rotating the rough core, so that the cutting tool 312 cuts an index grove 230 in the rough core’s exterior surface 215 a selected distance below the rough core’s upper edge portion 220. As discussed in greater detail below, the index groove 230 provides a location for a holding assembly, such as a lathe chuck, to engage and support the rough core while being rotated by another lathe.

In the illustrated embodiment, the arm 325 of the cutting assembly 320 is pivotable or otherwise movable about the proximal portion from a disengaged position with the cutting assembly 320 and cutting tool 340 spaced away from the rough core 200, and a cutting position with the cutting tool 340 engaging the exterior surface 215 of the rough core 200 to form the index groove 230 in the exterior surface 215. Accordingly, the index groove 230 is a ring cut into the rough core 200 substantially parallel to the upper edge portion 220 and a location spaced a relatively large distance away from the curved bottom end portion 225 of the rough core 200. In some embodiments, the distal portion 330 of the cutting assembly’s arm 325 has a handle 345 configured for an operator to grasp and control the pivoting motion of the arm between the disengaged position and the cutting position and for controlling the pressure applied by the cutting tool 340 to the rotating rough core 200, thereby controlling the cut rate and depth while cutting the index groove 230 into the exterior of the rough core 200.

In further embodiments, the cutting assembly 320 can be positioned level with the rough core 200 in the disengaged and cutting position, and the cutting tool 340 can be positioned spaced apart from the rough core 200 in the disengaged position and positioned in contact with the rough core 200 in the cutting position. More specifically, the cutting tool 340 can be rotated via the arm 325 to contact the rough core 200. In some embodiments, the cutting tool 340 can be a router bit.

The position of the cutting tool 312 can be adjusted relative to the rough core 200 to control where the index groove is cut on the rough core. The position of the cutting tool 312 can also be adjustable to carefully control the location of the index groove 230 on the rough core 200. While the illustrated embodiment shows only one index groove 230 on the rough core 200, other embodiments can be configured to machine two or more parallel index grooves 230 in the exterior surface 215 of the rough core 200. Although the illustrated embodiment is described as having a concave index groove around the circumference of the core, other embodiments can have one or more index features on the exterior of the rough core at a position generally closer to the upper edge portion to which engagement members of a lathe chuck can securely hold the rough core during subsequent machining of portions of the rough core. The index features can be formed into the exterior of the rough core either via lathe operation or other machining operation. Alternatively, the index features can be formed as projections extending from the exterior surface of the rough core so that the selected lathe can attach to the projecting index features. In yet other embodiments, the rough core may include a full or partial indexing groove alone or in addition to projecting index features.

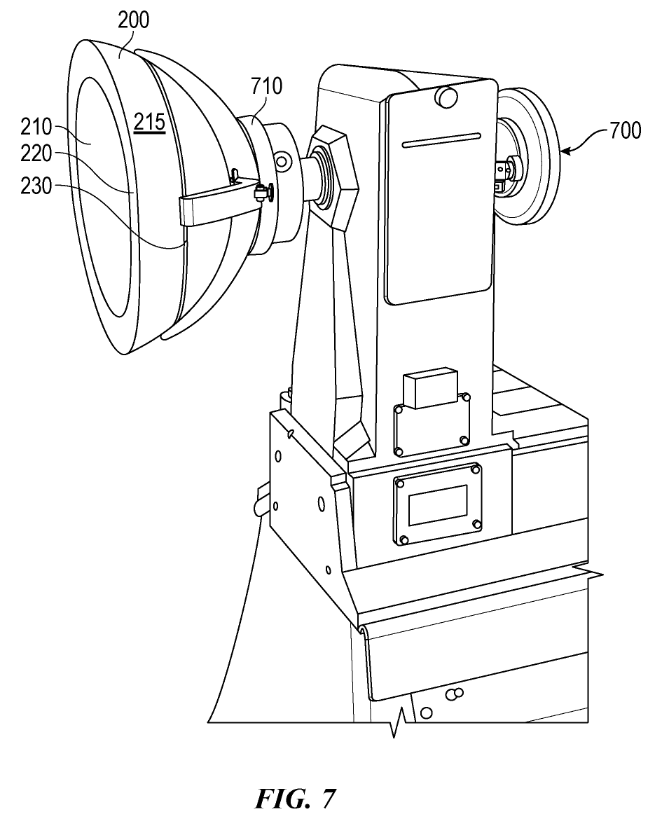

In accordance with one or more embodiments of the present technology illustrated in FIG. 6, the rough core 200 has a maximum outer diameter “D” defined by a radially outer corner of the upper edge portion 220. The index groove 230 is cut into the rough core 200 below the upper edge portion 220, so that the index groove 230 has a diameter less than the outer diameter D of the upper edge portion 220. In addition, the index groove 230 or other index feature(s) is located at a selected height “H” above the rough core’s bottom end portion 225. Each rough core 200 has an Aspect Ratio corresponding to the rough core’s diameter D relative to the index feature’s height H (i.e., D/H). As an example, the rough core 200 of the embodiment shown in FIG. 6 has a diameter D of approximately fifteen inches (15”), and the index groove 230 is located at a height of approximately three inches (3”) above the bottom end portion 225, so that the rough core 200 has an Aspect Ratio of approximately 5. For production of wooden bowls from rough cores 200 having approximately semispherical shapes, the rough cores preferably have an Aspect Ratio of approximately 5 or less (but greater than zero). In some embodiments, the Aspect Ratio is in the range of approximately 1.5–5.5, and preferably in the range of approximately 2.5-5, and more preferably in the range of approximately 3–5. This arrangement allows the mounting chuck to engage and support a significant portion of the rough core 200, which provides a stronger connection and greater stability in holding the rough core 200 during the machining processes. This greater stability in holding the rough core 200 can allow for using higher tool engagement pressures or faster tool paths, which can result in more consistent finished bowls and higher efficiency of the manufacturing process.

After the first coring knife 315a (FIG. 4C) cuts the rough core’s exterior surface 215 and the after the cutting tool forms the index groove 230 (FIG. 4D) or other index feature(s), the first coring knife 315a can be removed from the lathe 300 and replaced with a second curved coring knife 315b (FIG. 4E) that has a smaller radius than the first coring knife 315a. Accordingly, the cutting surface of the second coring knife 315b will engage the flat face 250 of the rough core 200 radially inward from the exterior surface 215. As the rough core 200 is rotating on the lathe 300 and the second coring knife 315b is pressed into rough core 200, the second coring knife 315b follows a path radially inward and substantially parallel to the rough core’s exterior surface 215, thereby cutting and forming the concave interior surface 210. When the cut forming the concave interior surface 210 is complete, the rough core 200 with its index groove 230, or other index feature(s), is separated from the remaining portion of the billet that will still be affixed on the screw chuck 310. This remaining portion of the billet also has a partially spherical shape, such that it could be further machined to apply an index groove and form a second rough core with a smaller diameter. This process may be repeated one or more times if there is enough wood remaining from the original billet.

After the rough core 200 is created with its convex exterior surface 215, the concave interior surface 210, and the index groove 230 (or other index feature(s)), the rough core 200 is moved to a second lathe assembly at the turning and cutting station 150 (FIG. 1) for further machining. FIG. 7 illustrates the rough core 200 that is securely held at the index groove 230 by a workpiece holding assembly, such as a star chuck assembly 710, removably mounted on a lathe 700 in accordance with aspects of the present technology. The index groove 230 is configured and positioned in the rough core’s exterior surface 215 at a location below the upper edge portion 220 to allow the star chuck assembly 710 to securely hold the rough core in axial alignment with the lathe 700 (discussed in greater detail below), so that rough core 200 can be rotated on the lathe 700 with the concave interior surface accessible for machining via a lathe tool. In addition, because the star chuck assembly 610 engages the rough core 200 at the index groove 230, the area of the rough core’s exterior surface 215 above the index groove 230 and the rough core’s upper edge portion 220 are also exposed and available for machining while in the star chuck assembly 710 without having to reposition the rough core 200 when on the lathe. With this arrangement, the star chuck assembly 710 supports a very large area of the rough core 200 while turning on the lathe 700, which provides significant stability and control to resist the forces generated by engagement with the lathe’s cutting tools or other machining tools during formation of the wooden bowl.

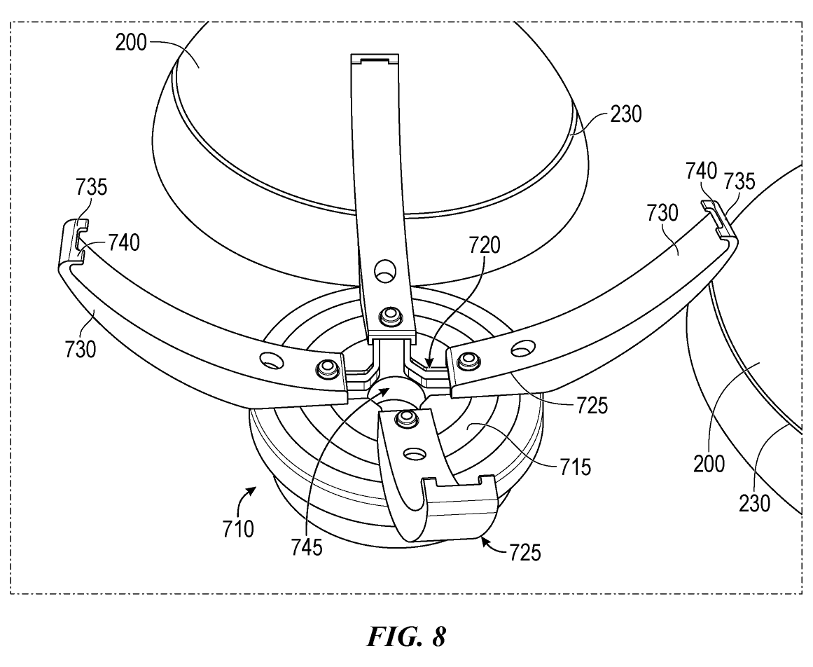

FIG. 8 is an enlarged image illustrating the star chuck assembly 710 of FIG. 7 shown removed from the lathe 700. The star chuck assembly 710 of the illustrated embodiment has a base 715 that removably attaches to and is rotated by the lathe’s spindle. The base 715 has a plurality of radially disposed slots 720 that slidably receive the proximal ends of a plurality of curved jaw arms 725. In the illustrated embodiment, the star chuck assembly 710 has four jaw arms 725 symmetrically and radially disposed on the base 715. In other embodiments, star chuck assembly 710 can have two, three, five, six, or more jaw arms 725. The positions of the jaw arms 725 are radially adjustable along the slots 720 in the base to increase or decrease the distance between free distal ends 730 of the jaw arms 725.

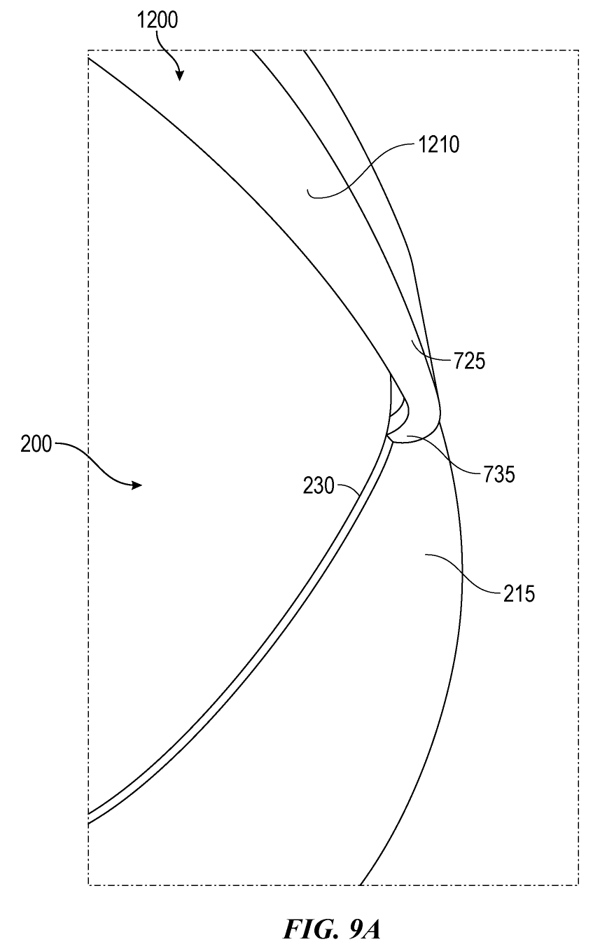

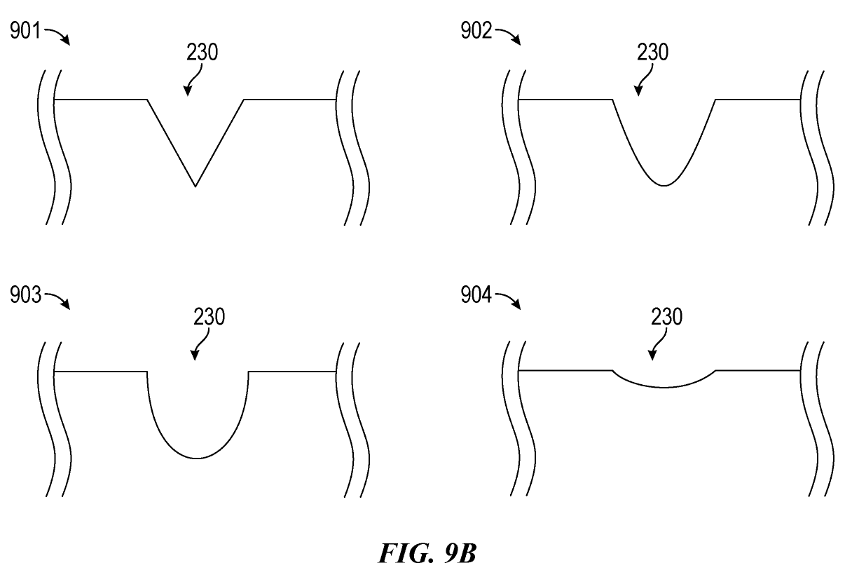

As seen in FIGS. 8 and 9A, the free distal end 730 of each jaw arm 725 has a thin hooked edge portion 735 that extends radially inwardly and that is sized to fit in the index groove 230 of a rough core 200 (FIG. 7). Accordingly, the jaw arms 725 can be opened (i.e., moved radially outwardly) enough so that the rough core 200 can be positioned between the distal ends 730 of the jaw arms 725 and with the thin edge portions 735 in alignment with the index groove 230. The position of the jaw arms 725 can then be adjusted radially inwardly until the thin edge portions 735 extend into the index groove 230 to securely hold the rough core in a fixed position relative to the jaw arms 725 and the base 715, so that the rough core 200 and the star chuck assembly 710 will rotate together as a unit upon rotation by the lathe 700.

In some embodiments, the index groove 230 can be cut to have a selected profile shape. As seen in FIG. 9B, the index groove 230 can have a profile with a generally V-shape (901), a generally U-shape (902), a partially oval shape (903), a partially circular shape, a shallow arcuate shape (904), a deep arcuate shape, or another selected groove profile shape. The cross-sectional profile of the jaw arm’s distal edge portion 735 can be complementary to the cross-sectional profile of the index groove 230. The distal edge portion 735 can have one or more points or projections 740 to allow for selected points of contact between the edge portion 735 and the index groove 230. In other embodiments, the edge portion 735 may be generally straight and configured so that substantially the entire edge portion engages the index groove 230. The illustrated jaw arms 725 all have the same shape and size. In other embodiments, the jaw arms 725 can have different shapes and sizes, to engage different ones of a plurality of index grooves 230 machined at different heights on the rough core 200.

The proximal end of each curved jaw arm 725 is connected to a threaded adjustment mechanism 745 in the base 715 configured to move the proximal end of the jaw arms 725 radially along a respective slot 720 in the base 715 to open or close the jaw arms 725 relative to the chuck’s axis of rotation. In some embodiments, the adjustment mechanism 745 can be a scrolling or self-centering chuck adjustment mechanism coupled to all of the jaw arms 725 so as to radially move all of the jaw arms 725 simultaneously relative to the base 715 upon tightening or loosening the adjustment mechanism. In other embodiments, the proximal end of each jaw arm 725 can be attached to its own separate threaded adjustment device configured to adjust the radial position of the respective jaw arm 725 independently. Other embodiments can use other adjustment mechanisms to control the position of the jaw arms to clamp onto or release the rough core 200 from the jaw arms, thereby moving the edge portions 735 of the jaw arms 725 firmly into or out of the index groove 230.

This configuration of the star chuck engaging the rough core at the index groove provides significantly improved gripping capabilities on the workpiece, such that the workpiece is more secure within the chuck, which enables a more efficient lathe operating technique. For example, a lathe operating technique can include the use of higher tool engagement pressures and faster tool paths applied to the surface of a workpiece. Utilizing higher pressures and faster tool paths not only cuts down on manufacturing time and labor costs but also promotes uniformity across multiple workpieces.

As indicated above and shown in FIG. 7, when the rough core 200 is affixed in the star chuck assembly 610, the chuck is attached to the lathe 700, the jaw arms 725 rigidly hold the rough core 200 at the index groove 230, so that the rough core’s concave interior surface 210, the upper edge portion 220, and the upper portion of the convex exterior surface 215 above the index groove 230 are exposed and accessible when rotated on lathe for cutting or machining these surfaces by selected lathe tools to provide substantially finished dimensions and surfaces. Once the upper edge portion 220 and/or the upper portion of the convex exterior surface 215 above the index groove 230 are machined to their substantially finished dimensions and surfaces, the partially machined rough core 200 can be removed from the star chuck assembly 710, positioned on another chuck or other workpiece holding assembly that provide machining access to the rest of the convex exterior surface 215 of the rough core 200, and turned on a lathe for machining and substantially finishing the exterior surface to result in the desired wooden bowl product.

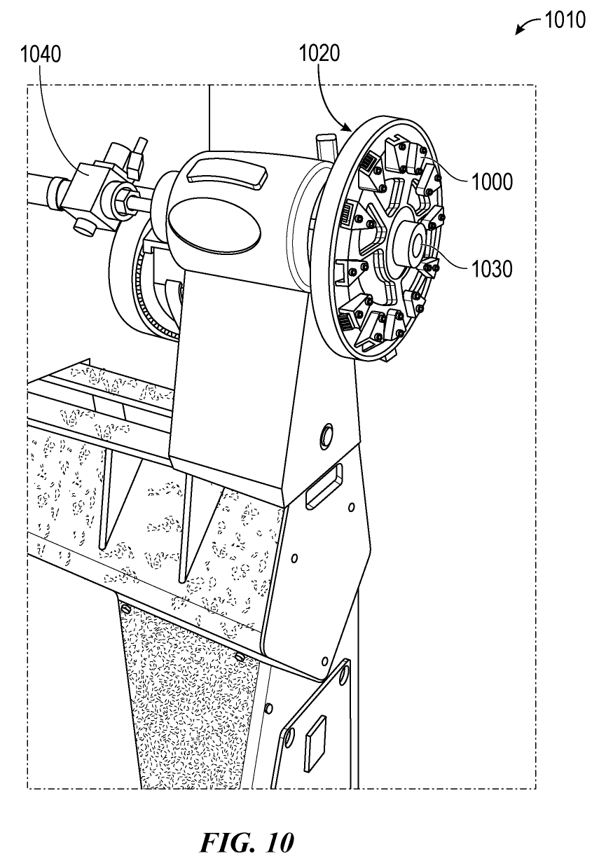

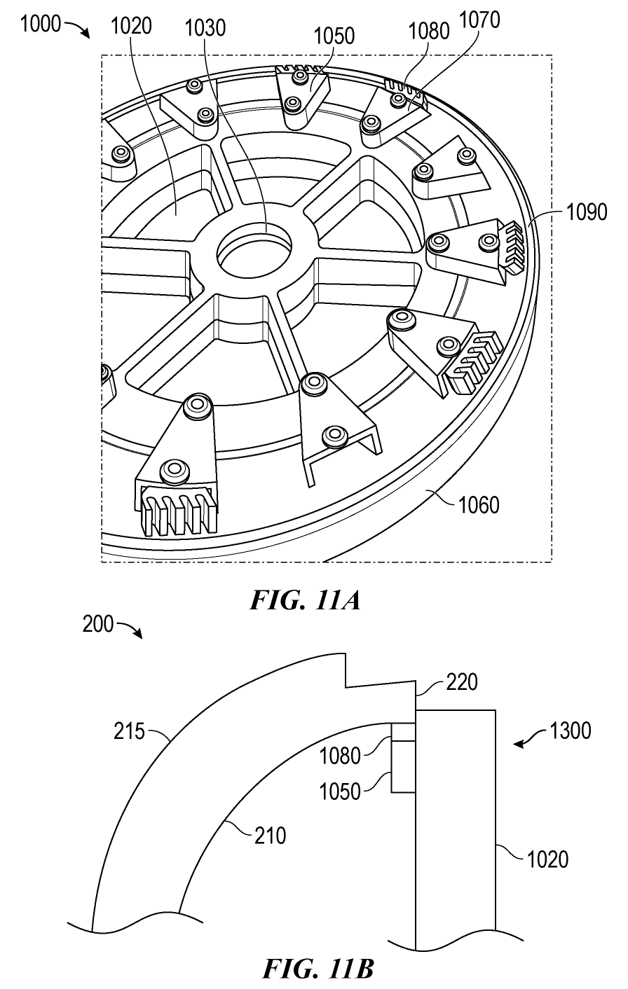

In at least one embodiment, the lathe system includes a vacuum chuck assembly configured to fixedly hold partially machined rough core 200 on a lathe and in a position to machine the rest of the rough core’s convex exterior surface, including the bottom end of the rough core. FIGS. 10 and 11A illustrate a vacuum chuck 1000 of at least one embodiment attachable to a lathe 1010 (FIG. 10) of the lathe system 10 (FIG. 1). The vacuum chuck 1000 is configured to hold the upper edge portion 220 of the rough core 200, so that the rest of the exterior surface extends away from the vacuum chuck and is positioned for access by a cutting tool or other machining tool. In the illustrated embodiment, the vacuum chuck 1000 had a cylindrical base plate 1020 configured to support the rough core 200 in a coaxial alignment and so that the rough core’s upper edge portion 220 is held flush against the base plate 1020. The base plate 1020 of the illustrated embodiment has an axially aligned central vacuum port 1030 in the base plate 1020 that will be surrounded by the rough core 200 and facing the concave interior surface when the rough core 200 is mounted to the vacuum chuck 1000. The vacuum port 1030 communicates with a vacuum source via a vacuum modulator 1040 connected to the lathe 1010 (FIG. 10). Accordingly, the vacuum source and vacuum modulator 1040 are activatable to draw a vacuum (i.e., negative or reduced pressure) through the vacuum port 1030 in the base plate 1020 of the vacuum chuck 1000, so as to create a partial vacuum within the interior area of the rough core 200 mounted to the vacuum chuck 1000. This partial vacuum sucks the rough core’s upper edge portion 220 against the base plate 1020 and helps hold the rough core 200 in a fixed position on the vacuum chuck 1000 for rotation as a unit upon rotation of the spindle of the lathe 1010. A workpiece mounted to the vacuum chuck 1000 can also be retained on the base plate 1020 by additional mechanical features, such as retainers disposed on the base plate 1020.

The cylindrical base plate 1020 of the illustrated vacuum chuck 1000 has a plurality of adjustable workpiece retainers 1050 attached to the base plate 1020 radially inward of the base plate’s circular outer edge 1060. The retainers 1050 are positioned and sized so that, when the partially finished rough core 200 is mounted on the vacuum chuck 1000, the retainers 1050 engage the core’s interior surface adjacent to its upper edge portion around its internal circumference. Accordingly, the retainers 1050 hold the rough core 200 in axial alignment with the base plate 1020 and prevent lateral or radial movement of the rough core relative to the base plate 1020 once mounted to the vacuum chuck 1000.

In the illustrated embodiment, the retainers 1050 can include a retainer body 1070 fastened to selected positions around the base plate 1020. Some or all of the retainers 1050 can also have a flexure portion 1080 attached to the retainer body 1070, wherein each flexure portion 1080 has finger-like projections extending radially outward at a selected angle toward the base plate’s circular outer edge 1060. In other embodiments, the flexure portion 1080 can include a flexible blade that extends radially outward around an outer edge of the retainer body 1070, or the flexure portion 1080 can include a flexible bulb tip, such as a hollow or compressible tube, that is affixed to the outer edge of the retainer body 1070. The flexure portions 1080 are configured so that, when the rough core 200 is mounted on the vacuum chuck 1000, the flexure portions 1080 firmly engage the core’s finished interior surface adjacent to the upper edge portion 220 and slightly flex to maintain a radially outward engaging force to help position and hold the rough core in axial alignment with the base plate 1020. In some embodiments, the flexure portions 1080 are made from a flexible material, such as rubber or plastic, that provides frictional engagement with the rough core when mounted on the vacuum chuck 1000. The flexure portions 1080 may be replaceably attached to the retainer body 1070 to allow for fine-tuning adjustment or replacement if worn over time. In some embodiments, the retainers 1050 can form a continuous ring that is concentric with the base plate’s circular outer edge 1060, or, in other embodiments, the retainers 1050 can be segmented with multiple distinct retainer bodies 1070.

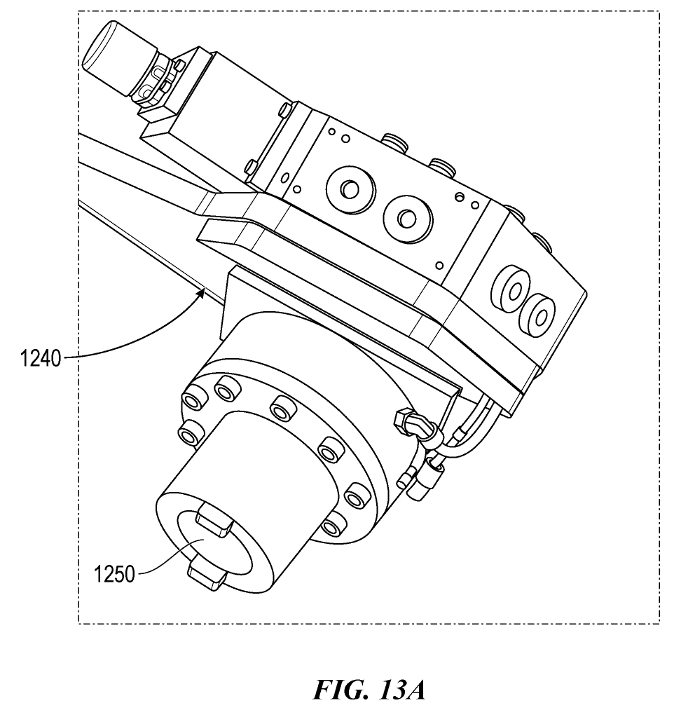

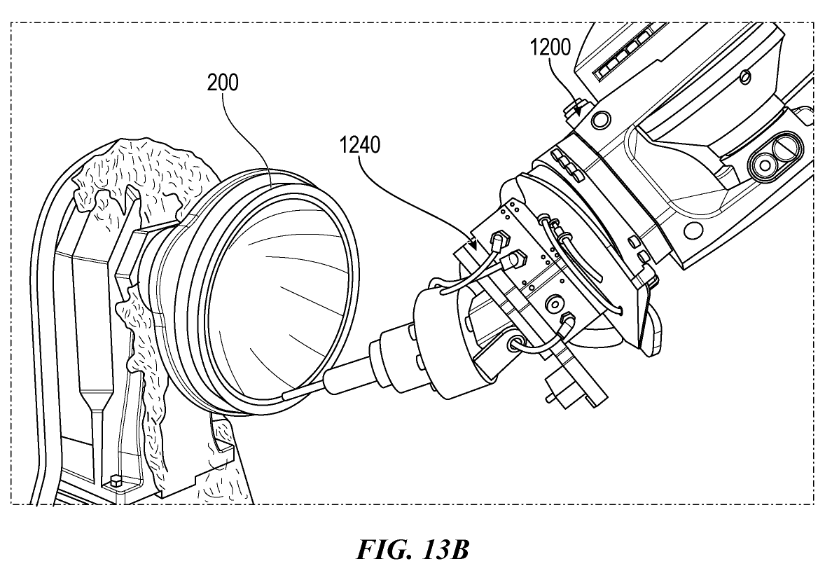

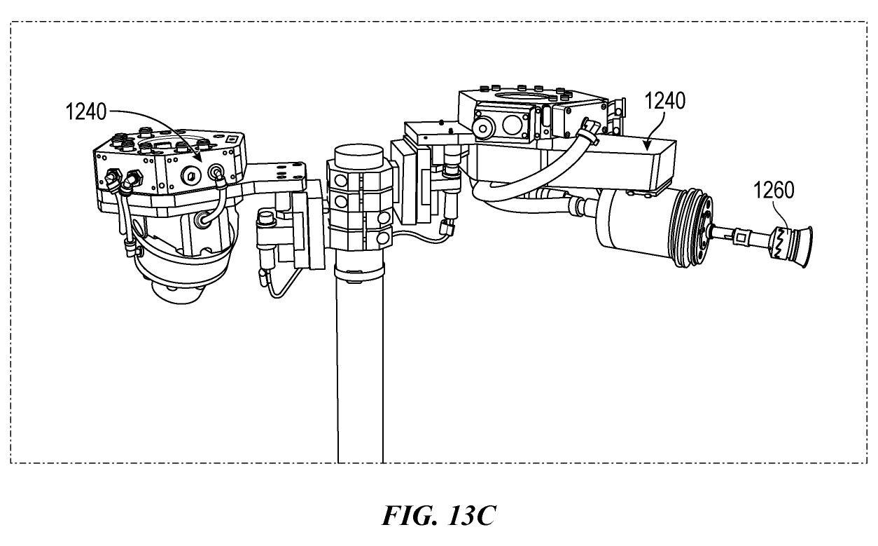

The vacuum chuck 1000 of the embodiment illustrated in FIGS. 7 and 13A has a sealing ring 1090 extending around the radially outward portion of the base plate 1020 and adjacent to the plurality of retainers 1050. The sealing ring 1090 is positioned to sealably engage the upper edge portion 220 of the rough core 200 when mounted on the vacuum chuck 1000 to help maintain the partial vacuum within the core’s interior area when the vacuum source is activated. The sealing ring 1090 can be a relatively flexible, durable material, such as a non-breathable rubber O-ring, plastic O-ring, or foam.

As seen in FIG. 11B, one or more embodiments of the vacuum chuck 1000 include the cylindrical base plate 1020 with a circular outer portion that has an outer diameter larger than the inner diameter of the rough core’s upper edge portion 220, but smaller than the upper edge portion’s 220 outer diameter. Accordingly, when the partially finished rough core 200 is mounted on the vacuum chuck 1000, part of the rough core’s upper edge portion 220 is supported against the base plate (and firmly engaging the sealing ring 1090), and a radially outward portion of the upper edge portion 220 extends past the edge of the base plate. This configuration helps position and maintain the convex exterior surface 215 of the rough core 200 away from the base plate. This also minimizes the risk of a cutting or finishing tool inadvertently contacting the base plate during the machining process on the lathe, particularly as material from the rest of the rough’s core’s convex exterior surface is cut or otherwise machined away to match the partially finished upper portion of the exterior surface as discussed above.

In some embodiments, a mounting device, such as a star chuck 1210 or vacuum chuck 1000, need not be decoupled from a lathe for a workpiece to be removed from the mounting device. For example, a star chuck 1210 can be coupled to a lathe and a rough core can be removed from the star chuck 1210 without first decoupling the star chuck 1210 from the lathe. It should also be understood that a rough core can be mounted to a mounting device, such as a star chuck 1210 or vacuum chuck 1000, while the mounting device is coupled to a lathe.

The configuration of the rough core 200 with the index groove 230 allows the entire exterior surface 215, interior surface 210, and upper edge portion 220 of the rough core 200 to be machined via the lathes and machining tools (e.g., cutting tools, finishing materials, sanding materials, etc.) by positioning the rough core on only two lathe chucks to result in the finished or substantially finished wooden bowl product. Positioning the rough core on only two lathe chucks greatly decreases the manual labor needed and increases the repeatability of making wooden bowls consistently in large-volume production operations. This process of making wooden bowls via the rough cores as discussed above could be achieved using the two workpiece holding assemblies, such as the star chuck assembly and the vacuum assembly, on a single lathe station, although other lathe stations could be used. For example, the star chuck assembly can be used on one lathe to machine the concave interior surface, the upper edge portion, and the upper portion of the exterior surface of a first rough core. Once the machining is completed using the star chuck, the partially finished first rough core can be removed, and a second rough core can be loaded onto the star chuck assembly on the first lathe. The removed partially finished rough core can be loaded onto the vacuum chuck on the second lathe to machine the rest of the exterior surface. Accordingly, the machining processes can be performed sequentially or simultaneously on the first and second rough cores using the two lathes and associated chucks, thereby increasing the efficiency and repeatability of the wooden bowl making process.

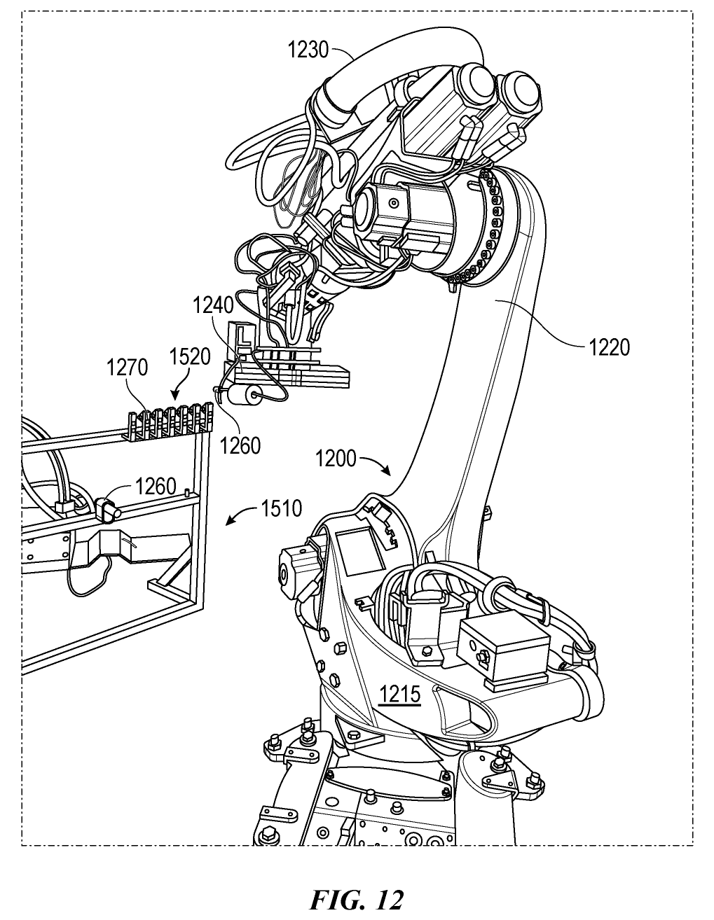

In some embodiments, the lathe machining processes discussed above can be automated processes using computer-controlled robotic systems with robotic arms that can pick up and use end effectors with selected cutting and/or machining tools to engage and machine the rough cores rotating on one or more lathes. For example, FIG. 12 is an image illustrating an automated robotic assembly 1200 of the lathe system 10 to hold and position cutting and other machining tools to machine the interior and exterior surfaces of the rough core to form the wooden bowl in accordance with embodiments of the technology disclosed herein. In some embodiments, the robotic assembly 1200 can be a robotic system at the Turning and Cutting Station 150 discussed above in connection with FIG. 1. The robotic assembly 1200 can be a multi-axis system with a base 1215 that supports articulatable first and second arm segments 1220 and 1230 that can selectively move in three dimensions relative to the lathes and associated rough cores mounted on the respective chuck assemblies as discussed above. In some embodiments, the first and second arm segments 1220 and 1230 can include articulable joints, axes, and/or segments that are able to position and orient the robotic assembly 1200 relative to the one or more lathes.

In the illustrated embodiment, the first arm segment 1220 is pivotably mounted at a proximal end to the base 1215, and the proximal end of the second arm segment 1230 is rigidly mounted to the distal end of the first arm segment 1220. An end effector 1240 is pivotably mounted to the distal end of the second arm segment 1230 and is configured to selectively pick up, use, and return cutting, sanding, or other machining tools for machining the one or more rough cores rotating on one or more lathes. The robotic assembly 1200 of the illustrated embodiment is a six-axis robotic system, although other embodiments can include a robotic assembly 1200 with a different number of axes of rotation. The robotic assembly 1200 can be computer-controlled, such that the end effector 1240 and associated machining tool are calibrated and move along defined paths and locations relative to the lathes and the rotating rough cores so the machining tools engage, cut, sand or otherwise form a finished wooden bowl with the determined shape, size and configuration.

FIGS. 13A and 13B illustrate an embodiment of one of multiple end effectors 1240 of the robotic assembly 1200 of FIG. 12 in accordance with an embodiment of the present technology. FIG. 13C illustrates end effectors 1240 removed from the robot and stored in a tool station. The end effector 1240 has an attachment portion that can be removably connected to the free distal end of the robot’s second arm segment 1230, such as a wrist of the second arm segment 1230. The end effector 1240 also has a receiving end 1250 configured to receive and securely hold a selected lathe tool 1260, such as a cutting tool (e.g., a gouge, chisel, scraper, or other cutting blade end) or a finishing tool (e.g., a sanding tool, a polishing tool, etc.). In some embodiments, the robotic assembly 1200 can have multiple end effectors, each configured for use with multiple tools, such that the end effector can pick up a selected lathe tool for various portions of the machining processes used in formation of the wooden bowl. Upon completion of the machining process, the end effector can change tools to provide a desired tool for further machining. In addition, the robotic assembly 1200 can utilize multiple backup end effectors 1240 for use with selected lathe tools 1260, so that if a cutting tool on one end effector 1240 is in need of maintenance, that end effector 1240 can be removed and replaced by a backup end effector 1240.

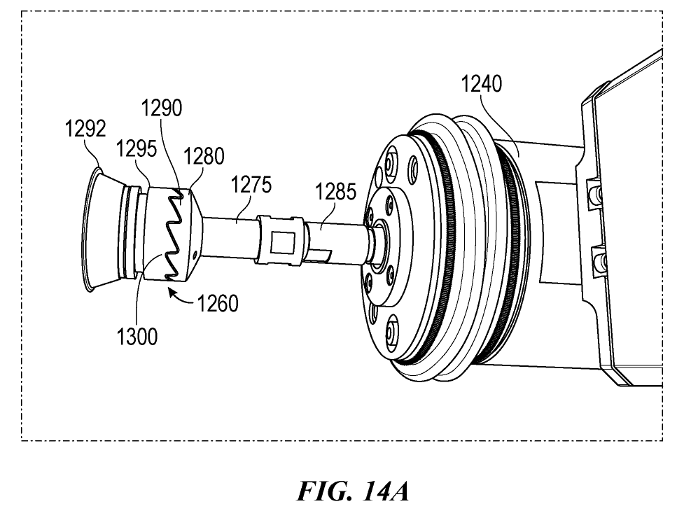

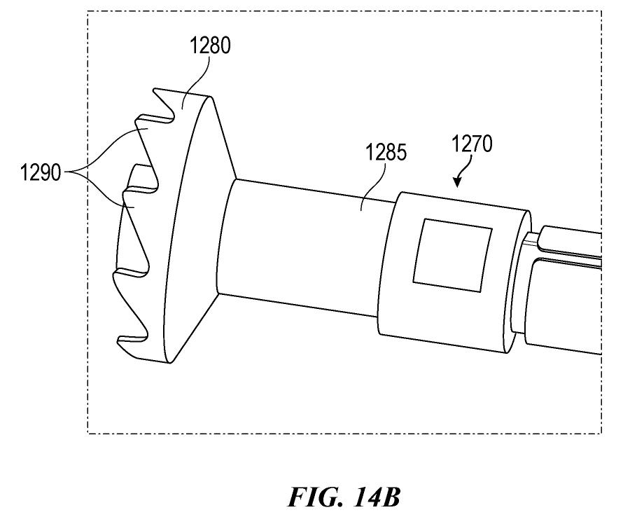

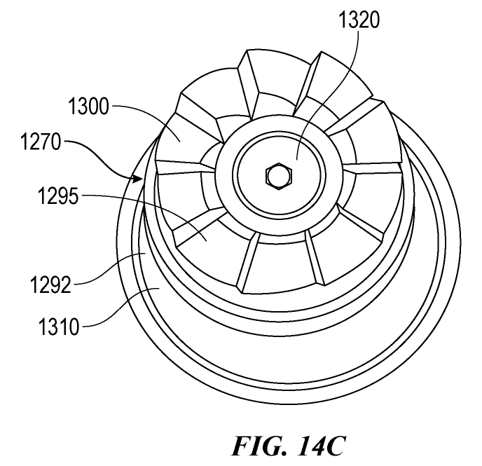

In some embodiments, the lathe tool 1260 can be a multi-part tool with a connect/disconnect portion so replacement tool portions can be connected and disconnected while using the same end effector 1240 on the distal end of the robot’s second arm segment 1230. For example, FIGS. 14A-14C illustrate mating portions of finishing tool 1270, such as a sanding disc tool for sanding the surfaces of the wooden bowl formed from the rough core after the cutting processes as discussed above. The finishing tool 1270 of the illustrated embodiment has a proximal portion 1275 with a connector 1280 that is received and secured in the end effector 1240 (FIG. 13A). The connector 1280 illustrated in FIG. 14A has a shaft 1285 extending from an engagement end (not pictured) that releasably connects to the end effector 1240 (FIG. 13A). The other end of the shaft 1285 can have a plurality of drive teeth 1290.

As seen in FIG. 14C, the finishing tool 1270 has a distal portion 1292 with a second connector 1295 configured to releasably connect to the first connector 1280 of the proximal portion 1275. In the illustrated embodiment, the second proximal connector 1295 has a plurality of drive teeth 1300 configured to mate with the drive teeth 1290 of the proximal drive portion 1275, so as to matingly engage, position, and axially align the distal and proximal portions 1275 and 1292 of the finishing tool 1270. The distal portion 1292 of the finishing tool also has a free tool end 1310 coupled to the second connector 1295. The free tool end 1310 has a tool head forming the machining tool that engages the rough core or partially finished wooden bowl. In the illustrated embodiment, at least one of the distal and proximal portions 1275 and 1292 has an axially aligned magnet 1320, and the other portion has an axially aligned magnet or magnetic material (e.g., ferrous material) that magnetically engage to hold the portions together, while the drive teeth 1290 and 1300 remain in engagement to prevent rotation of the distal portion 1292 in at least one direction relative to the proximal portion 1275. It should be understood, though, that first connector 1280 and/or the second connector 1295 can comprise other engagement means, such as, but not limited to, interlocking means or frictional engagement means, among others.

The tool 1270 illustrated in FIGS. 14A and 14B can include a distal portion 1292 with a variety of configurations capable of engaging a workpiece mounted to a lathe to accomplish a variety of lathe operating techniques. For example, in some embodiments, the distal portion 1292 can have a shape suitable for cutting or turning. In other embodiments, the distal portion 1292 is suitable for sanding or polishing the surfaces of the wooden bowl. In some embodiments, a plurality of finishing tools 1270 with sanding disks are provided with different degrees of coarseness. For example, the plurality of finishing tools 1270 can provide multiple sanding disks with a variety of grits, such as 40 grit, 60 grit, 80 grit, 120 grit, 200 grit, 400 grit, 800 grit, 1200 grit, or finer. Other embodiments can use other ranges of coarseness from quite coarse to a very fine coarseness for finalized or substantially polished bowl surfaces. Accordingly, the robotic system can utilize the end effector that has a sanding tool that can use an engagement end with a sanding disc of a selected grit or coarseness.

When the sanding process with that grit is completed or when the sanding disk is worn out, the robotic arm can move to a tool station, remove the engagement end, and pick up a replacement engagement end with another sanding disk with a different grit or with a fresh sanding disk. The robotic arm can then move the replacement engagement end to bring the selected sanding disk into engagement with the surface of the bowl to further smooth out and finish the bowl’s surface. When the sanding process is completed, the robotic arm can change tools and/or end effectors for any next machining step to complete the process of making the wooden bowl from the rough core.

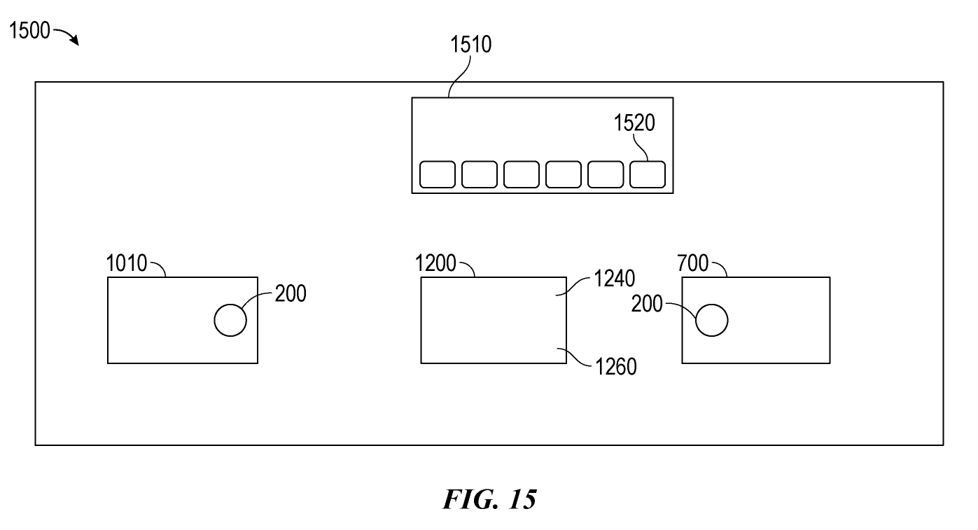

In some embodiments, the robotic assembly 1200 can be included in one or more lathe stations configured for automated manufacturing of wooden bowls from rough cores formed at the coring station 100 discussed above in connection with FIG. 1. For example, FIG. 15 illustrates a schematic of lathe station 1500, which can include the turning and cutting station 150 (FIG. 1) discussed above. Lathe station 1500 of the illustrated embodiment can include a first lathe 700 spaced apart from a second lathe 1010, and the robotic assembly 1200 generally adjacent to the first and second lathes 700 and 1010, so that the robotic arms and the end effector 1240 and associated tool 1260 can reach and engage the rough cores mounted to each of the lathes to automatically perform the selected machining process in formation of the wooden bowl. The lathe station 1500 of the illustrated embodiment shows the use of two lathes, although other embodiments can have a lathe system with a single lathe or more than two lathes. The lathe station 1500 can also include one or more tool stations 1510 that can include multiple end effector holders in positions and orientations that allow the robotic arm to pick up or return end effector 1240 from or to the tool station 1510 during the machining processes performed at the two lathes 700 and 1010.

The tool stations 1510 can include a plurality of tool holders 1520 configured to contain the various cutting tools and/or finishing tools used to make the wooden bowls on the lathes. For example, the tool stations 1510 can have two, three, four, five, six, seven, eight, or more tool holders 1520. Each tool holder 1520 is configured to releasably secure a tool 1260 in a defined orientation for engagement with the robotic arm and end effectors. For example, one or more tool stations can include racks of tools with sanding disks in designated positions. Another tool station can include the cutting tools for controllably removing wood from the rough cores to make the substantially finished wooden bowls.

In some embodiments, robotic assembly 1200 is calibrated relative to the tool stations and relative to the first and second lathes 700 and 1010 for precise control of the arm and tools relative to the workpieces on the lathes. The robotic assembly 1200 can be programmed to move an end effector 1240 proximate to an empty tool holder 1520, such that end effector 1240 can deposit a tool 1260 into the empty tool holder 1520 and pick up a different tool from another portion of the tool holder 1520 or from another tool holder 1520.

The robotic assembly 1200 with the selected end effector and tool can then be moved along a selected path relative to the first or second lathe to perform the cutting or finishing operation on the rotating rough core mounted on the chuck of the associated lathe. When the cutting or finishing operation is completed, the robotic arm can move back to the tool stations to return a tool and pick up another selected tool and move to the rough core on, for example, the same lathe (e.g., the first lathe 600) or the rough core on the other lathe (e.g., the second lathe 1010). The robotic assembly 1200 proceeds through defined lathe processing steps until, for example, the partially finished rough core can be removed from the star chuck on the first lathe 600 and moved to the vacuum chuck of the second lathe, wherein the rest of the lathe processes are automatically completed via the robotic assembly 1200. Upon completion, the finished wooden bowl is removed from the vacuum chuck and replaced by another rough core that has been removed from the star chuck on the first lathe 600. This process can be automatically repeated so as to provide a relatively high-volume production of wooden bowls with great consistency and repeatability.

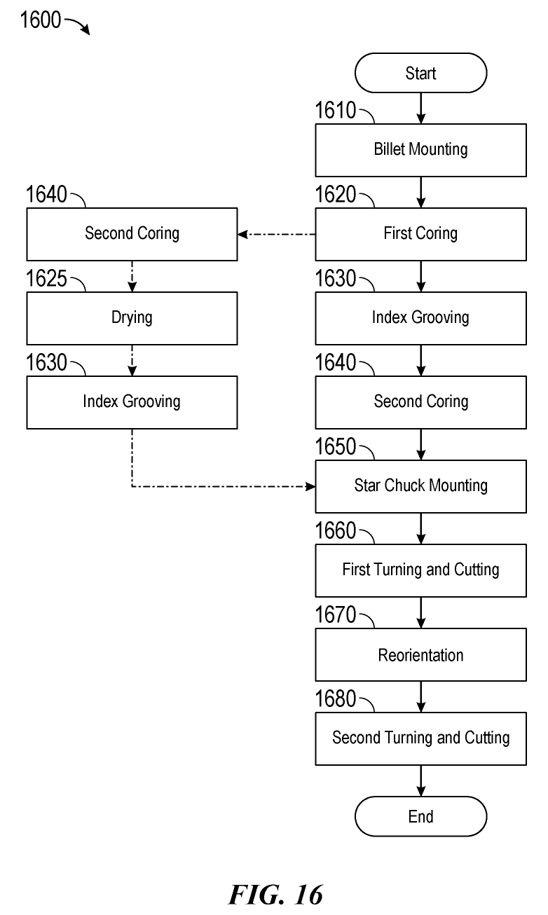

FIG. 16 is a schematic flow chart providing an example of at least one process of manufacturing a wooden bowl from a billet with the lathe system in accordance with embodiments of the present technology. The method 1600, as outlined in FIG. 16, can include the following steps: a Billet Mounting 1610 step, a First Coring 1620 step, an Index Grooving 1630 step, a Second Coring 1640 step, a Star Chuck Mounting 1650 step, a First Turning and Cutting 1660 step, a Reorientation 1670 step, and a Second Turning and Cutting 1680 step. It is noted that the method 1600 allows for a continuous process and production of finished cores. While the method 1600 is depicted with arrows indicating a flow from one step to the next, it’s not a strictly linear process where one step occurs in isolation. For instance, while a first billet is undergoing the First Coring 1620 step, a first rough core can be in the First Turning and Cutting 1660 step, and a second rough core can be in the Reorientation 1670 step. Other combinations of multiple steps occurring simultaneously are also possible and are considered by the present technology.

The Billet Mounting 1610 step comprises mounting a billet to a first mounting device, such as a lathe screw chuck, and attaching the mounting device to a first lathe. In other embodiments, the first mounting device can be coupled to the first lathe before the billet is mounted to the first mounting device. The First Coring 1620 step comprises a first lathe machining operation to machine a core of selected material from the billet. In some embodiments, for example, the first lathe machining operation is a first coring to cut the billet with the curved coring knife or other cutting tool to provide a partially semispherical core from the billet. The substantially spherical core remains mounted to the first mounting device after completion of the First Coring 1620 step.

The Index Grooving 1630 step comprises machining an index groove into the convex exterior surface of the core while the core is still mounted on the first lathe. In some embodiments, the index groove is machined in a location so that the core has an Aspect Ratio of approximately 5 or less. The Second Coring 1640 step comprises a second coring by machining a second semispherical cut in the core with a curved coring knife or tool with a smaller radius to provide a rough core with a concave interior surface. Upon completion of this second coring, the rough core is separated from the billet material that remains on the first lathe. The resulting rough core may be further processed immediately, or it may be stored in selected environmental conditions to cure or season the rough core.

In some embodiments, the Index Grooving 1630 step can be initially skipped, and the Second Coring 1640 step can be completed to produce the rough core without the indexing groove. Then, the rough core can be removed from the first mounting device for drying. For example, the rough core can be placed in a dryer, in dry conditions, and/or the like until the moisture content of the rough core is substantially reduced. Once the rough core is dried, the rough core can be removably coupled to a chuck, such as the vacuum chuck 1000, of an additional lathe, and the Index Grooving 1630 step can be completed. Completing the Index Grooving 1630 step after the rough core is dry can reduce the amount of material loss during the lathe cutting process because of shape changes that can occur to the core during drying.

Once the rough core includes the index groove, it is provided for the Star Chuck Mounting 1650 step, which comprises mounting it to a second lathe mounting device, such as a star chuck that engages the rough core at the index groove and provides supports about the bottom portion of the rough core below the index groove. The star chuck and rough core are then mounted as a unit to the spindle of a second lathe.

The First Turning and Cutting 1660 step comprises machining (i.e., turning, cutting, sanding, or otherwise removing material) portions of the rough core, including the concave interior surface, the upper edge portion, and an upper portion of the convex exterior surface above the index groove and the engaging arms of the star chuck. This machining process provides substantially finished surfaces on portions of the rough core that are accessible while being in the star chuck. This First Turning and Cutting 1660 step can be performed in an automated station using a computer-controlled robotic system with a multi-axis robotic arm, end effectors, and selected cutting or machining tools.

The Reorientation 1670 step comprises removing the partially finished rough core from the second mounting device (e.g., the star chuck) and mounting it in a third mounting device in a second orientation to provide access to the remaining unfinished portions of the rough core, namely the convex exterior adjacent to and below the index groove. The third mounting device can be a vacuum chuck attachable to the third lathe coupled to a vacuum system. The Reorientation 1670 step can be completed while the second mounting device is coupled to the second lathe or while the second mounting device is removed from the lathe. Further, the partially finished rough core can be mounted on the third mounting device (e.g., the vacuum chuck) while it is coupled to a lathe or before the vacuum chuck is attached to the lathe. Also, once the partially finished rough core is removed from the star chuck, it can be replaced by another rough core ready for machining.

The Second Turning and Cutting 1680 step comprises machining (i.e., turning, cutting, sanding, or otherwise removing material) the unfinished portions of the rough core, including the rest of the convex exterior surface adjacent to and below the index groove. This machining step will result in removing material from the rough core in which the index groove was formed, thereby substantially finishing the rest of the core to result in a wooden bowl. This Second Turning and Cutting 1660 step can also be performed in the automated station using the computer-controlled robotic system with a multi-axis robotic arm, end effectors, and selected cutting or machining tools. In other embodiments, the Second Turning and Cutting 1660 step can be performed in a different automated station using a computer-controlled robotic system with a multi-axis robotic arm, end effectors and selected cutting or machining tools.

The result of the Star Chuck Mounting 1650 step, the First Turning and Cutting 1660 step, the Reorientation 1670 step, and the Second Turning and Cutting 1680 step, a finished wooden bowl can be produced from the rough core having an index groove. The method 1600 of the present technology can include a plurality of lathe stations. For example, Billet Mounting 1610 step, the First Coring 1620 step, the Index Grooving 1630 step, and the Second Coring 1640 step can occur at a first lathe station. A second lathe station can include the Star Chuck Mounting 1650 step, the First Turning and Cutting 1660 step, the Reorientation 1670 step, and the Second Turning and Cutting 1680 step.

The above method allows for production of a wooden bowl by mounting the rough core on only two mounting devices (e.g., the star chuck and the vacuum chuck). This greatly increases the efficiency of making wooden bowls on lathe systems and decreases the inconsistencies or misalignments that can occur when having to reposition a workpiece multiple times for machining on a lathe. It also allows for increased efficiencies and volume throughput by using robotic machining, which also helps reduce labor costs and improve workpiece consistency.

The above description and drawings are illustrative and are not to be construed as limiting. Numerous specific details are described to provide a thorough understanding of the disclosure. However, in some instances, well-known details are not described in order to avoid obscuring the description. Further, various modifications can be made without deviating from the scope of the embodiments.

Reference in this specification to "one embodiment" or "an embodiment" means that a particular feature, structure, or characteristic described in connection with the embodiment is included in at least one embodiment of the disclosure. The appearances of the phrase "in one embodiment" in various places in the specification are not necessarily all referring to the same embodiment, nor are separate or alternative embodiments mutually exclusive of other embodiments. Moreover, various features are described that can be exhibited by some embodiments and not by others. Similarly, various requirements are described which can be requirements for some embodiments but not for other embodiments.

As used herein, the word "or" refers to any possible permutation of a set of items. For example, the phrase "A, B, or C" refers to at least one of A, B, C, or any combination thereof, such as any of: A; B; C; A and B; A and C; B and C; A, B, and C; or multiple of any item such as A and A; B, B, and C; A, A, B, C, and C; etc.

The terms used in this specification generally have their ordinary meanings in the art, within the context of the disclosure, and in the specific context where each term is used. It will be appreciated that the same thing can be said in more than one way. Consequently, alternative language and synonyms can be used for any one or more of the terms discussed herein, and any special significance is not to be placed upon whether a term is elaborated or discussed herein. Synonyms for some terms are provided. A recital of one or more synonyms does not exclude the use of other synonyms. The disclosure herein is not limited to various embodiments given in this specification. Unless otherwise defined, all technical and scientific terms used herein have the same meaning as commonly understood by one of ordinary skill in the art to which this disclosure pertains. In the case of conflict, the present document, including definitions, will control.

I claim:

1. A method of machining a bowl from a rough core, the method comprising:
mounting the rough core to a first chuck configured to mount to a first lathe, wherein the rough core is formed from a billet and includes a convex rough exterior surface, a concave rough interior surface, a rough top edge, and an index groove in the convex rough exterior surface adjacent to the rough top edge, wherein the first chuck has one or more adjustable engagement features that securely engage the convex rough exterior surface of the rough core in the index groove;
coupling the first chuck to the first lathe;
turning the rough core and the first chuck as a first unit about a first axis of rotation via the first lathe;
machining, with one or more cutting tools, the concave rough interior surface and the rough top edge of the rough core while turning via the first lathe to form an intermediate core with a machined interior surface and a machined top edge;
removing the intermediate core from the first chuck;
securing the intermediate core to a second chuck with the machined top edge in firm engagement with the second chuck, wherein the second chuck is configured to mount to the first lathe or a second lathe;
coupling the second chuck to the first lathe or the second lathe;
turning the intermediate core and the second chuck as a second unit via the first lathe or the second lathe;
machining with the one or more cutting tools the convex rough exterior surface to form the bowl with a machined exterior surface, wherein the machining of the convex rough exterior surface removes material of the intermediate core comprising the index groove to remove the index groove; and
removing the bowl from the second chuck.

2. The method of claim 1, further comprising forming, with a cutting assembly, the index groove in the convex rough exterior surface adjacent to the rough top edge, wherein the cutting assembly is configured to cut the index groove at a position to provide an aspect ratio corresponding to a maximum outer diameter of the rough core relative to a height of the index groove above a bottom end portion of the rough core, and wherein the aspect ratio is in a range of approximately 1.0–5.5.

3. The method of claim 2 wherein the cutting assembly is configured to cut the index groove at the position to provide the aspect ratio in a range of approximately 2.5–5.

4. The method of claim 1 wherein mounting the rough core to the first chuck comprises mounting the rough core to a star chuck via a plurality of jaw arms with engagement portions configured to securely engage the convex rough exterior surface in the index groove.

5. The method of claim 1, further comprising machining a portion of the convex rough exterior surface adjacent to the rough top edge or the machined top edge while the rough core and the first chuck are turning as the first unit about the first axis of rotation.

6. The method of claim 1 wherein mounting the intermediate core to the second chuck comprises mounting the intermediate core to a vacuum chuck with a plurality of engagement features configured to engage with the machined interior surface of the intermediate core adjacent to the machined top edge.

7. The method of claim 6, further comprising adjusting a position of the plurality of engagement features to align the intermediate core relative to a center of the vacuum chuck.

8. The method of claim 6 wherein the plurality of engagement features are at least one of deformable fingers, blades, or bulb tips, and wherein mounting the intermediate core to the vacuum chuck comprises partially deforming the plurality of engagement features and axially aligning the intermediate core with the vacuum chuck for rotation as the second unit via the first lathe or the second lathe.

9. The method of claim 1, further comprising sanding the machined interior surface while the intermediate core is attached to the first chuck and turning via the first lathe or the second chuck.

10. The method of claim 1 wherein the machining is performed by the one or more cutting tools removably attached to a robotic arm assembly and moved relative to the rough core and the first chuck turning as the first unit via the first lathe.

11. A lathe system, comprising:
one or more lathes each having a central axis of rotation and configured to rotate a workpiece about the central axis of rotation, wherein the workpiece has a convex rough external surface;
a cutting assembly comprising:
a movable arm;
a first cutting tool fixedly coupled to the movable arm; wherein the movable arm is configured to move the first cutting tool into engagement with the convex rough external surface of the workpiece while rotating about the central axis of rotation to form an index feature into the convex rough external surface adjacent to an upper edge portion of the workpiece; and
one or more second cutting tools configured to engage and remove material from a rough core formed from the workpiece; and
first and second chuck assemblies configured to removably mount to the one or more lathes and to releasably retain the rough core,
wherein the rough core comprises the convex rough external surface with the index feature formed therein, the upper edge portion, and a concave rough interior surface,
wherein the first chuck assembly comprises a plurality of adjustable engagement features that securely engage the convex rough external surface of the rough core in the index feature adjacent to the upper edge portion to rotate the rough core with the first chuck assembly as a unit in a position configured to allow material to be machined from the concave rough interior surface and the upper edge portion and a portion of the convex rough external surface between the upper edge portion and the index feature using the one or more second cutting tools to form a machined interior surface, a machined top edge of a bowl, and an intermediate core,
wherein the second chuck assembly comprises a mounting plate and a plurality of engagement features configured to engage with the machined interior surface of the intermediate core adjacent to the machined top edge of the bowl, and
wherein the second chuck assembly is configured to hold and rotate with the intermediate core in a configuration to allow material to be machined from the convex rough external surface, including a portion of the convex rough external surface comprising the index feature to form a machined exterior surface of the bowl, using the one or more second cutting tools.

12. The lathe system of claim 11 wherein the cutting assembly is configured to cut the index feature to form a circumferential groove around the convex rough external surface of the rough core substantially parallel to the upper edge portion.

13. The lathe system of claim 11 wherein the cutting assembly is configured to cut the index feature to have an aspect ratio corresponding to a maximum outer diameter of the rough core relative to a height of the index feature above a bottom end portion of the rough core, and wherein the aspect ratio is in a range of approximately 1.0–5.5.

14. The lathe system of claim 13 wherein the aspect ratio is between a range of approximately 2.5 and 5.

15. The lathe system of claim 11 wherein the second chuck assembly is a vacuum chuck configured to engage with the machined top edge and exert vacuum pressure to hold the intermediate core to hold in fixed engagement with the vacuum chuck.

16. The lathe system of claim 11, further comprising a plurality of sanding tools positionable to engage and sand the machined exterior surface, the machined interior surface, and/or the machined top edge of the bowl to provide a smoothed, sanded bowl.

17. The lathe system of claim 11, further comprising a robotic arm assembly wherein the second chuck assembly is a vacuum chuck configured to engage with the machined top edge and exert vacuum pressure to hold the intermediate core in fixed engagement with the vacuum chuck.

18. The lathe system of claim 11 wherein the first chuck assembly is a star chuck assembly comprising:
a base;
a plurality of curved jaw arms adjustably coupled to the base, each of the plurality of curved jaw arms having a free distal end with a hooked edge portion configured to extend at least partially into the index feature and engage the convex rough external surface; and
an adjustment mechanism configured to move the plurality of curved jaw arms radially relative to the base to hold onto or release the rough core from the plurality of curved jaw arms.

19. A lathe station system, comprising:
one or more lathes configured to rotate a workpiece about central axes of rotation;
a star chuck assembly mountable to the one or more lathes and comprising:
a base;
a plurality of curved jaw arms adjustably coupled to the base, each of the plurality of curved jaw arms having a distal end configured to extend at least partially into an index feature positioned on a convex exterior surface of the workpiece near a top edge portion of the workpiece; and
an adjustment mechanism configured to move the plurality of curved jaw arms radially relative to the base to hold onto or release the workpiece from the plurality of curved jaw arms;
a vacuum chuck assembly mountable to the one or more lathes and comprising:
a vacuum port configured to draw a vacuum; and
a plurality of engagement features configured to releasably engage with a concave interior surface of the workpiece; and
a robotic arm assembly having a connection member on a free end to releasably hold one or more cutting tools, wherein the robotic arm assembly is configured to move the one or more cutting tools to machine the concave interior surface, the top edge portion and a portion of the convex exterior surface between the index feature of the workpiece while the workpiece is mounted to the star chuck assembly, and configured to machine the convex exterior surface and the concave interior surface while the workpiece is mounted to the vacuum chuck assembly, such that material in which the index feature is formed is fully removed.

20. The lathe station system of claim 19, further comprising:
a first lathe station comprising a first lathe of the one or more lathes, wherein the workpiece is machined into a rough core at the first lathe station via a first curved coring knife and a second curved coring knife;
a second lathe station comprising a second lathe of the one or more lathes, wherein the index feature is cut into the rough core at the second lathe station via a cutting assembly; and
a third lathe station comprising a third lathe of the one or more lathes, wherein the rough core is machined into a bowl at the third lathe station via the robotic arm assembly.
